(19) United States
(12) Patent Application Publication
(10) Pub. No.: US 2017/0124770 A1
(43) Pub. Date: May 4, 2017

(54) SELF-DEMONSTRATING OBJECT FEATURES AND/OR OPERATIONS IN INTERACTIVE 3D-MODEL OF REAL OBJECT FOR UNDERSTANDING OBJECT'S FUNCTIONALITY

(71) Applicant: Nitin Vats, Meerut, Uttar Pradesh (IN)

(72) Inventor: Nitin Vats, Meerut, Uttar Pradesh (IN)

(21) Appl. No.: 15/126,538

(22) PCT Filed: Mar. 16, 2015
(86) PCT No.: PCT/IN2015/000130

§ 371 Date: Sep. 15, 2016

(30) Foreign Application Priority Data
Mar. 15, 2014 (IN) 429/DEL/2014

(51) Int. Cl. G06T 19/20; G06F 3/16; G06F 3/01; G06T 19/00; G06T 15/04

(52) U.S. Cl. CPC G06T 19/20; G06T 19/003; G06T 15/04; G06T 19/006; G06F 3/011; G06F 3/017; G06F 3/167; G06T 2200/04; G06T 2200/24; G06T 2219/2016; G06T 2219/2021; G06T 2200/08; G06T 2215/16; G06T 2219/016; G06T 2219/028

(57) ABSTRACT

A computer implemented method for visualization of a 3D model of an object, the method includes:
generating and displaying a first view of the 3D model;
receiving an user input, the user input are one or more interaction commands comprises interactions for understanding particular functionality of the 3D model, wherein functionality of the 3D model is demonstrated by automatic operation of the part/s of the 3D model which operates in an ordered manner to perform the particular functionality;
identifying one or more interaction commands;
in response to the identified command/s, rendering of corresponding interaction to 3D model of object with or without sound output using texture data, computer graphics data and selectively using sound data of the 3D-model of object; and
displaying the corresponding interaction to 3D model,
   wherein operating in Ordered manner includes parallel or sequential operation of part/s.

### FIELD OF THE INVENTION

The invention relates to visualizing a virtual model. More specifically, the invention relates to visualizing and interacting with the virtual model.

### BACKGROUND OF THE INVENTION

There is an increasing trend to display the real products digitally with the help of images, videos and/or animations. A user may not be aware of existing or new features in a real consumer product. Even in real situation, when users visit a physical establishment to see a real product, say a car, the users perform known and general interaction like opening of side door, moving steering wheel etc, however seek assistance of salesman to explain particular operation, feature or seek guidance as to how to use the product for easy understanding of the product. For example, a user may want to understand airbag operation, how adjust seats, etc. in case of car. Further, almost all product manufacturer and independent product reviewers make videos or shoot videos for explaining particular operation, feature or to guide as to how to use the product. Examples of independent product reviewers are sites like cnet.com, survey sites which explains features of some real object, say features of mobile, how to operate certain functionalities in a refrigerator etc. through video shoots. A lot of money, time and effort are usually spent to make such video shoots. Further, manufacturers provide a user guide and/or a features booklet to read, and a certain fraction of users usually search for videos in web to learn and understand about a new or existing product or its features, and a lot of time is spent in the process to understand a small functionality or feature. Additionally user may be lazy to ask multiple questions. In some implementation, such as discussed in Indian patent application Nos. 2253/DEL/2012, 332/DEL/2014 and PCT application PCT/IN2013/000448, filed by the same applicants as of this application, viewing and performing user-controlled interactions with one or more 3D models representing real products is carried out to visualize, and gain active product information. However, a user might not know what sequence of steps needs to be followed to get a desired result such as getting ice crushed in a refrigerator, steps to change gears etc in understanding detailed operations or functionality very quickly and accurately. Additionally, a manufacturer may want to deliberately promote or make users aware of certain advanced or differentiating features of a product in a virtual experience, while not limiting the freedom of performing interactions with a digital virtual model of object representing real product as per user choice.

The object of the invention is to provide a cost-effective and easy to use solution for explaining/ demonstrating particular operation, feature or to guide as to how to use a real product.

### SUMMARY OF THE INVENTION

The object of the invention is achieved by a method of claim 1, a system of claim 34 and a computer program product of claim 35.

According to one embodiment of the method, the method includes:
generating and displaying a first view of the 3D model;
receiving an user input, the user input are one or more interaction commands comprises interactions for understanding particular functionality of the 3D model, wherein functionality of the 3D model is demonstrated by automatic operation of the part/s of the 3D model which operates in an ordered manner to perform the particular functionality;
identifying one or more interaction commands;
in response to the identified command/s, rendering of corresponding interaction to 3D model of object with or without sound output using texture data, computer graphics data and selectively using sound data of the 3D-model of object; and
displaying the corresponding interaction to 3D model,
   Wherein operating in Ordered manner includes parallel or sequential operation of part/s.

According to another embodiment of the method, wherein other part/s of virtual object is available for user controlled interactions while such operation is being performed.

According to yet another embodiment of the method, wherein the demonstration of the particular functionality comprises demonstration of multiple steps, wherein the steps are controlled by pausing the step/s and/or replaying the step/s.

According to one embodiment of the method, wherein the object comprises an electronic screen and correspondingly the 3D model comprises a virtual electronic display, interacting with the 3D model for understanding functionality to navigate to an application in the 3D model and/or understating functionality of the application by automatically demonstrating the required step in ordered manner, wherein such demonstration is shown by change in graphics and/or multimedia data on the virtual electronic display in synchronization with automatically operating the part/s of virtual 3D model.

According to another embodiment of the method, wherein two or more 3D models of two or more objects which are communicatively coupled to each other, wherein interacting with 3D model/s for understanding a particular functionality pertaining communication among the 3D model/s by automatically demonstrating steps of operation of part/s and/or movement of 3D model/s and/or change in GUI/s of virtual electronic display or multimedia data of 3D model/s in ordered manner.

According to yet another embodiment of the method, wherein interaction to understand functionality of 3D model with gesture control comprises:
displaying virtual human body and/or virtual human body part/s with/without 3D model of gesturing object/s wherein gesturing object comprises a virtual object representing object used by human to give gesture command.
ordered artificial representation of gestures through movement/posture or activity of virtual human body and/or virtual human body part/s with/without 3D model of gesturing object/s in synchronization with operation of 3D model part/s or any movement of 3D model.

According to one embodiment of the method, wherein the 3D model comprises inflatable and/or deflatable and/or folding part/s, and interacting with the part/s to understand their inflation and/or deflation and/or folding feature by automatically demonstrating the inflation and/or deflation and/or folding of the part/s in ordered manner.

According to another embodiment of the method, wherein new 3D model/s of new object/s are introduced in interactive manner and/or isolated manner with the existing 3D model for automatically demonstrating the particular functionality in an ordered manner.

According to yet another embodiment of the method, wherein demonstration of the operation is further guided by text or voice, wherein the text or voice refers to the steps involved in performance of the operation.

According to one embodiment of the method, wherein a virtual character is introduced and the voice is lisped and/or expressed with/without facial expression and/or body posture.

According to another embodiment of the method, wherein the interaction command comprises extrusive interaction and/or intrusive interactions and/or a time bound change based interaction and/or a real environment mapping based interaction and combination thereof, as per user choice and/ or as per characteristics, state and nature of the said object, wherein the time bound changes refers to representation of changes in 3D model demonstrating change in physical property of object in a span of time on using or operating of the object, and real environment mapping refers to capturing a real time environment, mapping and simulating the real time environment to create a simulated environment for interacting with the 3D model.

According to yet another embodiment of the method, wherein the interaction commands are adapted to be received before and/or during and/or after interactions for understanding particular functionality of the 3D model.

According to one embodiment of the method, wherein the extrusive interaction comprises at least one of:
interacting with a 3D model representing an object having a display for experiencing functionality of Virtual GUI on virtual display of displayed 3D model; to produce the similar changes in corresponding GUI of 3D model as in GUI of the object for similar input;
interacting for operating and/or removing movable parts of the 3D model of the object, wherein operating the movable parts comprises sliding, turning, angularly moving, opening, closing, folding, and inflating-deflating the parts
interacting with 3D model of object for rotating the 3D model in 360 degree in different planes;
operating the light-emitting parts of 3D-model of object for experiencing functioning of the light emitting part/s, the functioning of the light emitting part/s comprises glowing or emission of the light from light emitting part/s in 3D-model in similar pattern that of light emitting part/s of the object;
interacting with 3D-model of object having representation of electronic display part/s of the object to display response in electronic display part of 3D-model similar to the response to be viewed in electronic display part/s of the object upon similar interaction;
interacting with 3D-model of object having representation of electrical/electronic control of the object to display response in the 3D-model similar to the response to be viewed in the object upon similar interaction;
interacting with 3D-model for producing sound effects; or combination thereof.

According to another embodiment of the method, wherein functioning of light emitting part is shown by a video as texture on surface of said light emitting part to represent lighting as dynamic texture change.

According to yet another embodiment of the method, the intrusive interactions comprises at least one of:
interacting with sub-parts of the 3D-model of the object, wherein sub-parts are those parts of the 3D-model which are moved and/or slided and/or rotated and/or operated for using the object;
interacting with internal parts of the 3D model, wherein the internal parts of the 3D -model represent parts of the object which are responsible for working of object but not required to be interacted for using the object, wherein interacting with internal parts comprising removing and/or disintegrating and-/or operating and/or rotating of the internal parts;
interacting for receiving an un-interrupted view of the interior of the 3D model of the object and/or the sub-parts;
interacting with part/s of the 3D model for visualizing the part by dismantling the part from the entire object;
interacting for creating transparency-opacity effect for converting the internal part to be viewed as opaque and remaining 3D model as transparent or nearly transparent;
disintegrating different parts of the object in exploded view; or combination thereof.

According to one embodiment of the method, wherein the real environment mapping based interactions comprises at least one of:
capturing an area in vicinity of the user, mapping and simulating the video/image of area of vicinity on a surface of 3D model to provide a mirror effect;
capturing an area in vicinity of the user, mapping and simulating the video/image of area of vicinity on a 3D space where 3D model is placed; or combination thereof.

According to another embodiment of the method, wherein the interaction comprises liquid and fumes flow based interaction for visualizing liquid and fumes flow in the 3D model with real-like texture in real-time.

According to yet another embodiment of the method, wherein the interaction comprises immersive interactions, the immersive interactions are defined as interactions where users visualize their own body performing user-controlled interactions with the virtual computer model.

According to one embodiment of the method, wherein displaying of new interaction/s to the 3D-model while previously one or more interaction has been performed or another interaction/s is being performed on the 3-D model.

According to another embodiment of the method, wherein rendering of corresponding interaction to 3D model of object in a way for displaying in a display system made of one or more electronic visual display or projection based display or combination thereof.

According to yet another embodiment of the method, wherein the display system is a wearable display or a non-wearable display or combination thereof.

According to one embodiment of the method, wherein the non-wearable display comprises electronic visual displays such as LCD, LED, Plasma, OLED, video wall, box shaped display or display made of more than one electronic visual display or projector based or combination thereof.

According to another embodiment of the method, wherein the non-wearable display comprises a pepper's ghost based display with one or more faces made up of transparent inclined foil/screen illuminated by projector/s and/or electronic display/s wherein projector and/or electronic display showing different image of same virtual object rendered with different camera angle at different faces of pepper's ghost based display giving an illusion of a virtual object placed at one places whose different sides are viewable through different face of display based on pepper's ghost technology.

According to yet another embodiment of the method, wherein the wearable display comprises head mounted display, the head mount display comprises either one or two small displays with lenses and semi-transparent mirrors embedded in a helmet, eyeglasses or visor. The display units are miniaturised and may include CRT, LCDs, Liquid crystal on silicon (LCos), or OLED or multiple micro-displays to increase total resolution and field of view.

According to one embodiment of the method, wherein the head mounted display comprises a see through head mount display or optical head-mounted display with one or two display for one or both eyes which further comprises curved mirror based display or waveguide based display.

According to another embodiment, wherein the head mounted display comprises video see through head mount display or immersive head mount display for fully 3D viewing of the 3D-model by feeding rendering of same view with two slightly different perspective to make a complete 3D viewing of the 3D-model.

According to yet another embodiment of the method, wherein the 3D model moves relative to movement of a wearer of the head-mount display in such a way to give to give an illusion of 3D model to be intact at one place while other sides of 3D model are available to be viewed and interacted by the wearer of head mount display by moving around intact 3D model.

According to one embodiment of the method, wherein the display system comprises a volumetric display to display the 3D model and interaction in three physical dimensions space, create 3-D imagery via the emission, scattering, beam splitter or through illumination from well-defined regions in three dimensional space, the volumetric 3-D displays are either auto stereoscopic or auto multiscopic to create 3-D imagery visible to an unaided eye, the volumetric display further comprises holographic and highly multiview displays displaying the 3D model by projecting a three-dimensional light field within a volume.

According to another embodiment of the method, wherein the display system comprises more than one electronic display/projection based display joined together at an angle to make an illusion of showing the 3D model inside the display system, wherein the 3D model is parted off in one or more parts, thereafter parts are skew in shape of respective display and displaying the skew parts in different displays to give an illusion of 3d model being inside display system.

According to yet another embodiment of the method, wherein the input command is received from one or more of a pointing device such as mouse; a keyboard; a gesture guided input or eye movement or voice command captured by a sensor, an infrared-based sensor; a touch input; input received by changing the positioning/orientation of accelerometer and/or gyroscope and/or magnetometer attached with wearable display or with mobile devices or with moving display; or a command to a virtual assistant.

According to one embodiment of the method, wherein command to the said virtual assistant system is a voice command or text or gesture based command, wherein virtual assistant system comprises a natural language processing component for processing of user input in form of words or sentences and artificial intelligence unit using static/dynamic answer set database to generate output in voice/text based response and/or interaction in 3D model.

### BRIEF DESCRIPTION OF THE DRAWINGS

FIG. 1(a)-FIG 1(c) illustrates an example of the invention where a virtual motorcycle is shown with demonstration of gear functioning.

FIG. 2(a)-FIG 2(d) illustrates an example of the invention where a virtual car is shown with demonstration of functioning of an airbag of the virtual car.

FIG. 3(a) FIG. 3(e) illustrates an example of the invention where automatic demonstration of interaction of a virtual television with a virtual remote.

FIG. 4(a)-FIG 4(b) illustrates an example of the invention where demonstrations of volume change of a virtual television using hand gestures.

FIG. 5(a)-FIG 5(c) illustrates an example of the invention where demonstration of automatic filling of virtual water and virtual ice in a virtual glass from a virtual refrigerator.

FIG. 6(a)-FIG 6(c) illustrates an example of the invention where a man appears wearing a see-through head mount display (HMD) and interacts with a virtual refrigerator for automatic demonstration of dispensing of ice.

FIG. 7(a)-FIG 7(c) illustrates an example of the invention where a man appears wearing an immersive head mount display (HMD) and interacts with a virtual refrigerator for automatic demonstration of dispensing of ice.

FIG. 8(a)-FIG 8(d) illustrates an example of the invention where a man appears wearing a see-through head mount display (HMD) and interacts with a virtual refrigerator for rotating a virtual refrigerator in different orientation and automatic demonstration of dispensing of ice.

FIG. 9(a)-FIG 9(d) illustrates an example of the invention where a man appears wearing an immersive head mount display (HMD) and interacts with a virtual refrigerator for rotating a virtual refrigerator in different orientation and automatic demonstration of dispensing of ice.

FIG. 10(a)-FIG 10(i) illustrates an example of the invention where a virtual mobile is interacted to rotate in various orientations and further interacted for demonstration of using a messaging application stored on the virtual mobile.

FIG. 11(a)-FIG. 11(b) illustrates an example of the invention where the 3D model is shown and interacted on a video wall.

FIG. 12(a)-FIG. 12(d) illustrates an example of the invention where the 3D model is shown and interacted on a cube based display.

FIG. 13(a)-FIG. 13(c) illustrates an example of the invention where the 3D model is shown and interacted on a holographic display.

FIG. 15 illustrates a block diagram of the system implementing the invention.

FIG. 16(a)-FIG. 16(b) illustrates a block diagram of another embodiment of the system implementing the invention.

### DETAILED DESCRIPTION

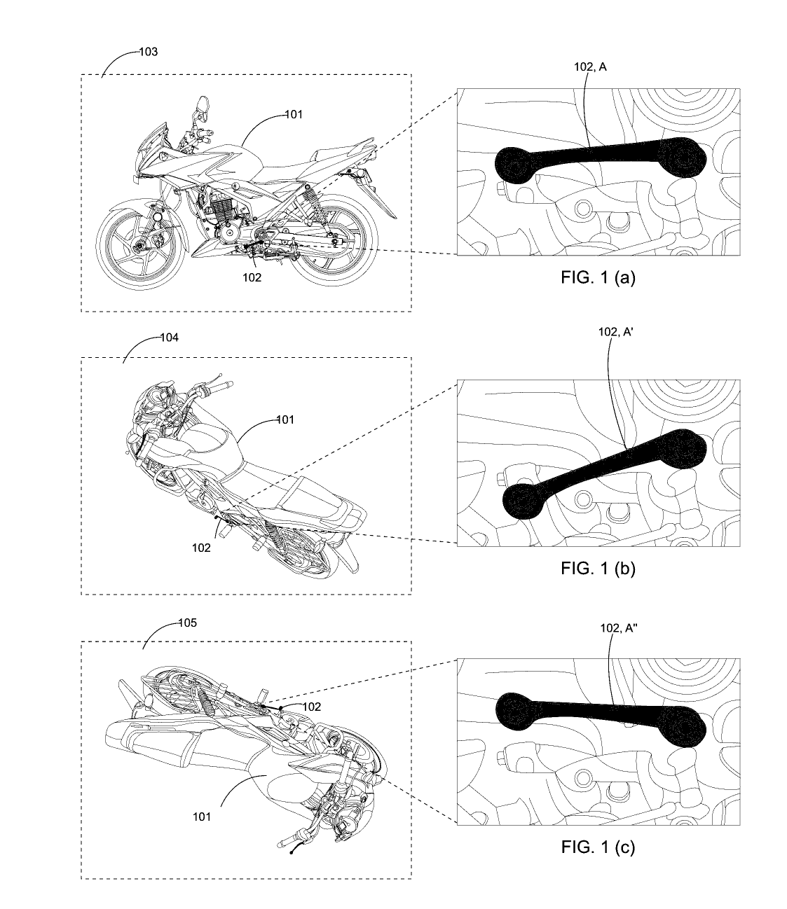

FIG. 1(a)-FIG 1(c) illustrates an example of the invention where a virtual motorcycle 101 is shown with demonstration of gear functioning. In FIG. 1(a), the virtual motorcycle 101 is shown in an orientation 103 with gear 102 at neutral position A. Here user selects for viewing demonstration of the gear functioning. In FIG. 1(b) and FIG. 1(c), automatic movement of gear is shown in ordered manner, where gear moves into first gear position A′ and then to the second gear position A″. While, the demonstration is going on, the user changes the orientation of virtual motorcycle 101 to different orientations 104 and 105. While demonstration is going on, user can rotate the virtual motorcycle 101 in 360 degrees to any orientation.

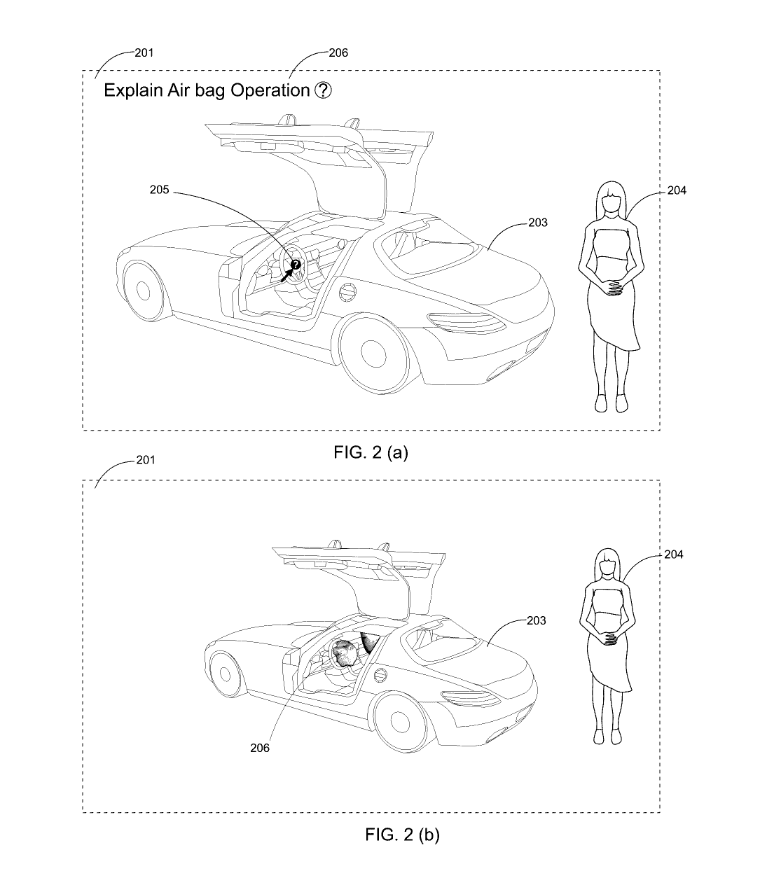

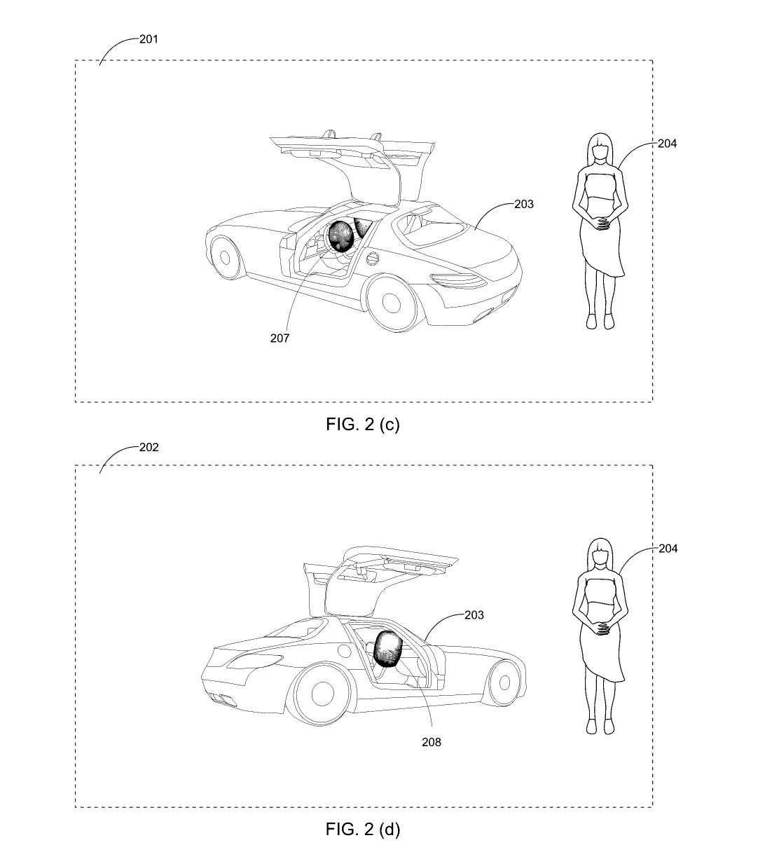

FIG. 2(a)-FIG 2(d) illustrates an example of the invention where a virtual car 203 is shown with demonstration of functioning of an airbag 205 of the virtual car 203. In FIG. 2(a), the virtual car 203 is shown in a particular orientation 201 with doors opened along with a virtual assistant 204. When a user points over the airbag 205 to understand functioning of the airbag 205, a text 206 appears “Explain Air bag operation”. User selects the text 206 to command for understanding functionality of the airbag 205. The virtual assistant 204 lisps the text 206 and further explains functioning of inflation of the air bag throughout the FIG. 2(a)-FIG. 2(c) along with facial expressions and body movement. In FIG. 2(b) FIG. 2(d) automatic and orderly inflating of the airbag 205 is shown and explained. In FIG. 2(d), the user rotates the virtual car 203 in a different orientation 202, while demonstration is going on. While demonstration is going on, user can rotate the virtual car 203 in 360 degrees to any orientation. Any part of the virtual car 203 can be interacted for user controlled interaction, as well as for self-demonstration of functionality of the part. The invention allows numerous ways which can be introduced to give command separately for user controlled interactions and interactions for self-demonstration of functionality using text, voice, gesture or input through any other input medium.

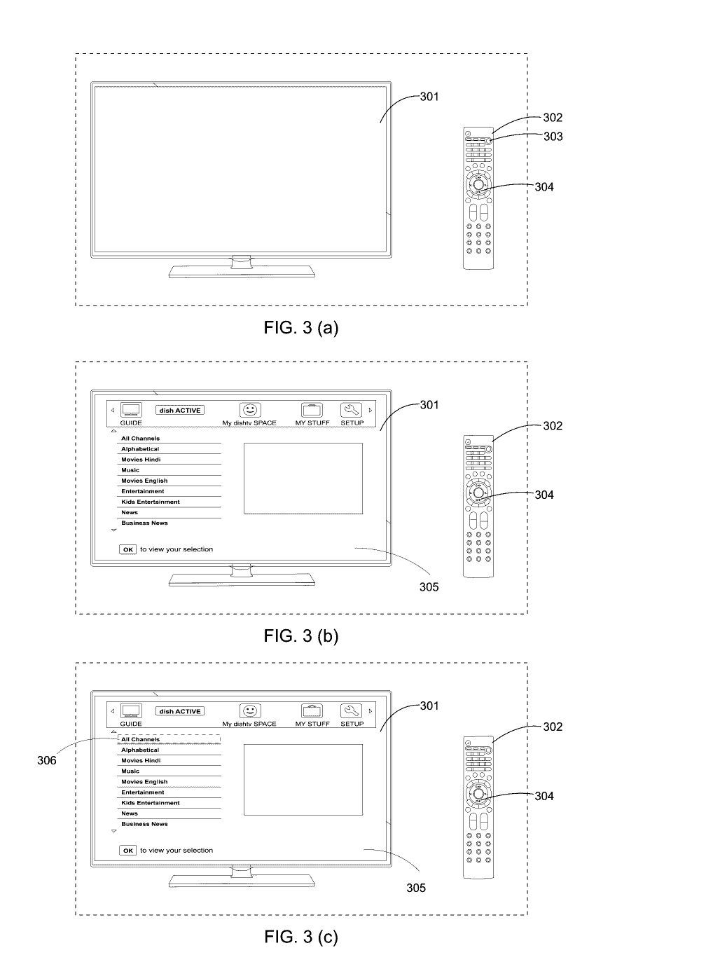

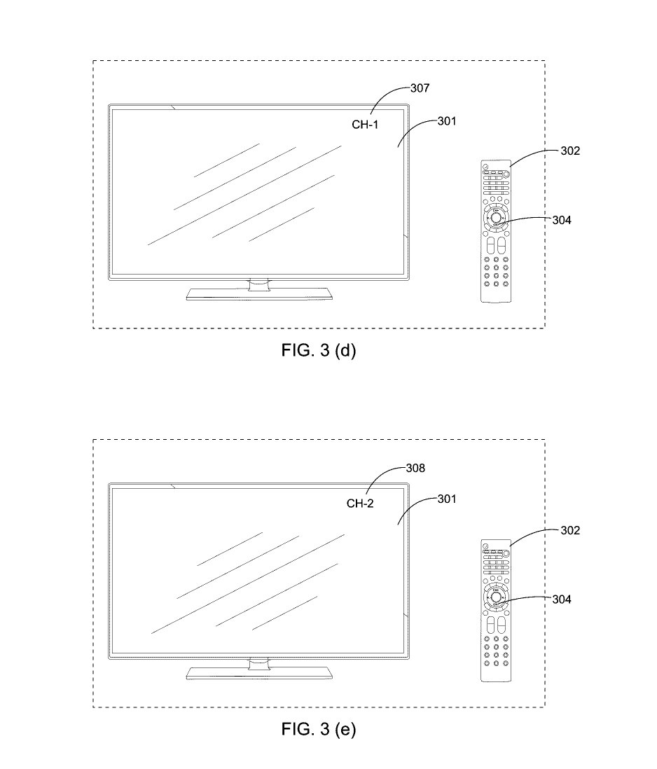

FIG. 3(a) FIG. 3(e) illustrates an example of the invention where automatic demonstration of interaction of a virtual television 301 with a virtual remote 302. In FIG. 3(a), the virtual television 301 is shown along with the virtual remote 302 with a power button 303. Demonstration for powering “on” of the television 301 is shown in FIG. 3(b), by automatic and orderly pressing of the button 303 and further switching “on” of the television 301. When the television is switched on, first interface of the television is displayed which is a TV guide. In FIG. 3(c), when the user requests for demonstrating functionality of change in channel, the button 304 is automatically and orderly pressed and further selection of “All channels” at the TV guide interface of the virtual television 301 is shown automatically. Further change of channels are shown automatically from TV guide interface to “CH-1” channel 1 to “CH2”channel 2 by automatic pressing of button 304, in FIG. 3(d) and FIG. 3(e).

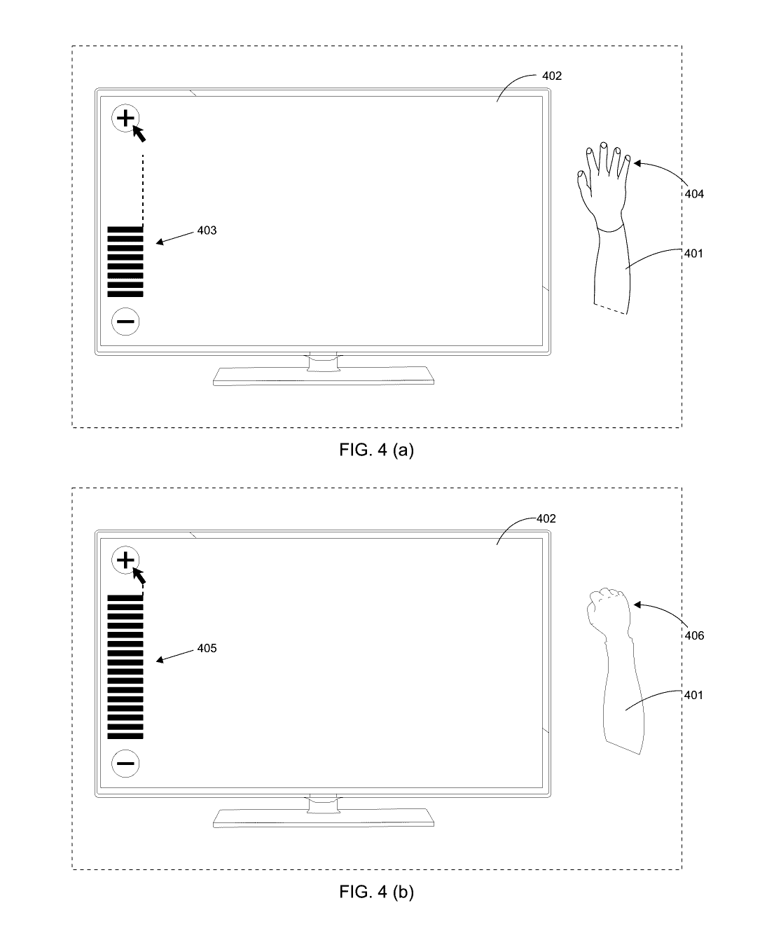

FIG. 4(a)-FIG 4(b) illustrates an example of the invention where demonstrations of volume change of a virtual television 402 using hand gestures. In FIG. 4(a), the virtual television 402 is shown along with a virtual hand 401 in a normal position 404 of fingers and a volume interface showing volume level at a particular intensity 403. The virtual hand 401 and the volume level interface appears when a user request for automatic demonstration of change in volume levels using gestures. In FIG. 4(b), automatic demonstration of volume level change is shown by moving finger position to 406 to increase volume intensity 405.

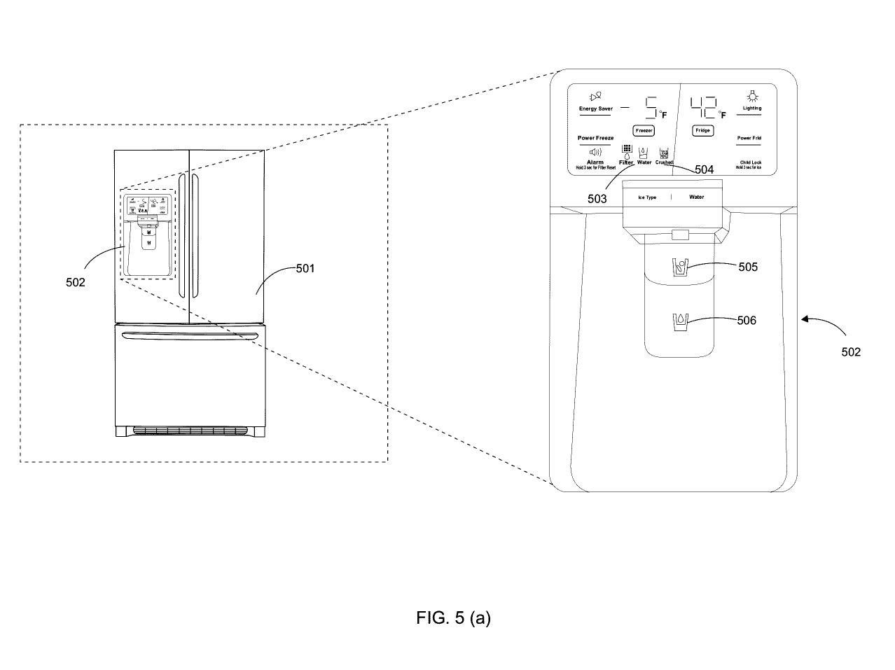

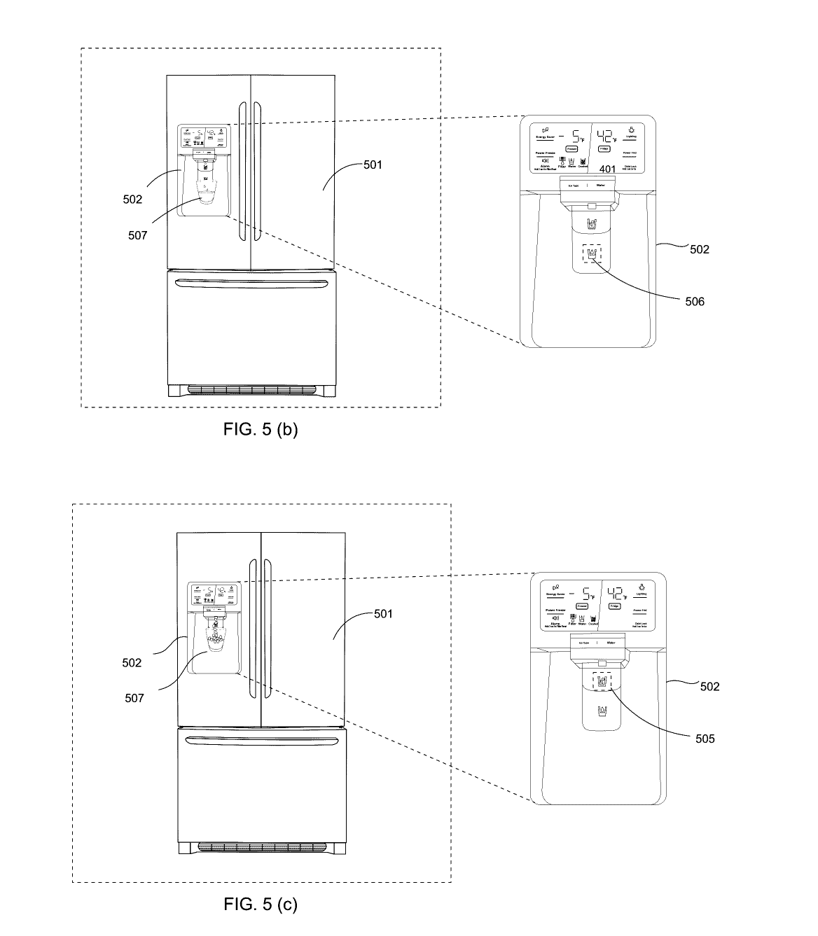

FIG. 5(a)-FIG 5(c) illustrates an example of the invention where demonstration of automatic filling of virtual water and virtual ice in a virtual glass 507 from a virtual refrigerator 501. In FIG. 5(a), the virtual refrigerator 501 is shown with a control panel 502 showing options 503 and 504 for dispensing ice and water from the refrigerator along with indications 505 and 506 for showing when water is dispensing and when ice is dispensing. When a user interacts for understanding functionality for dispensing of water, a virtual glass 507 appears and pressing of water dispensing control occurs automatically in an ordered manner as shown in FIG. 5(b). Further, water starts dispensing in the virtual glass 507 and also indication for water dispensing 506 is blown automatically and orderly, as shown in FIG. 5(b). Further, when user requests for demonstration of dispensing of ice in water filled virtual glass, 507, automatically ice dispensing control activates and further ice dispenses into the water-filled glass 507 automatically along with blowing of indicator 505 for dispensing of ice.

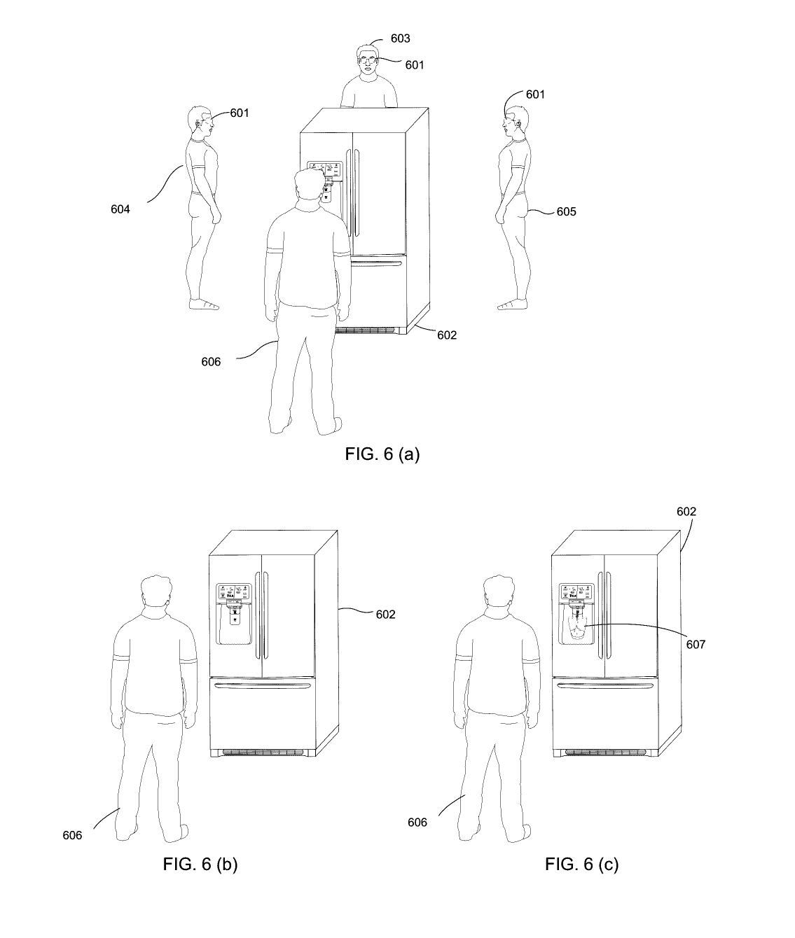

FIG. 6(a)-FIG 6(c) illustrates an example of the invention where a man appears wearing a see-through head mount display (HMD) 601 and interacts with a virtual refrigerator 602 for automatic demonstration of dispensing of ice. In FIG. 6(a), the man wearing the see-through HMD 601 moves to various locations 603, 604, 604, 606 around the virtual refrigerator 602 to see various parts of the virtual refrigerator 602, while the virtual refrigerator 602 seems to be intact at same position. In FIG. 6(b), the man moves to the location 606 which is facing front part of the virtual refrigerator 602 and interacts to the virtual refrigerator 602 to understand automatic dispensing of ice using a control panel of the virtual refrigerator 602. In FIG. 6(c), automatic orderly steps of appearing a virtual glass 607, pressing of a button on the control panel for controlling dispensing of ice, and dispensing of ice into the virtual glass 607, are shown.

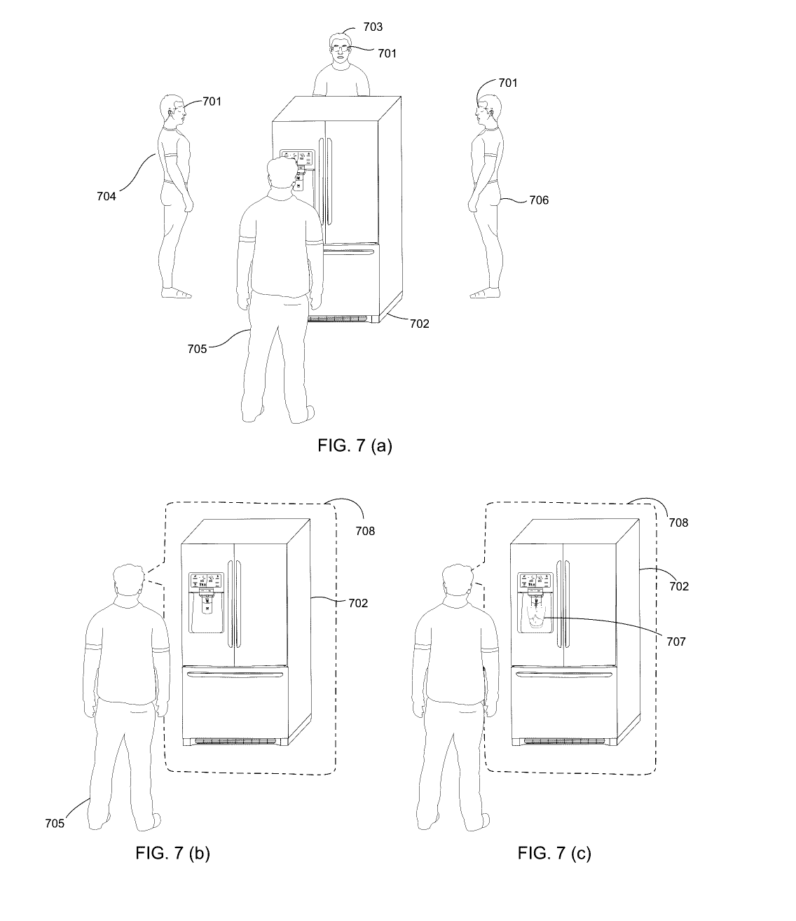

FIG. 7(a)-FIG 7(c) illustrates an example of the invention where a man appears wearing an immersive head mount display (HMD) 701 and interacts with a virtual refrigerator 702 for automatic demonstration of dispensing of ice. In FIG. 6(a), the man wearing the see-through HMD 701 moves to various locations 703, 704, 704, 706 around the virtual refrigerator 702 to see various parts of the virtual refrigerator 702, while the virtual refrigerator 702 seems to be intact at same position. In FIG. 6(b), the man moves to the location 706 which is facing front part of the virtual refrigerator 702 and interacts to the virtual refrigerator 702 to understand automatic dispensing of ice using a control panel of the virtual refrigerator 702. In FIG. 6(c), automatic orderly steps of appearing a virtual glass 707, pressing of a button on the control panel for controlling dispensing of ice, and dispensing of ice into the virtual glass 707, are shown.

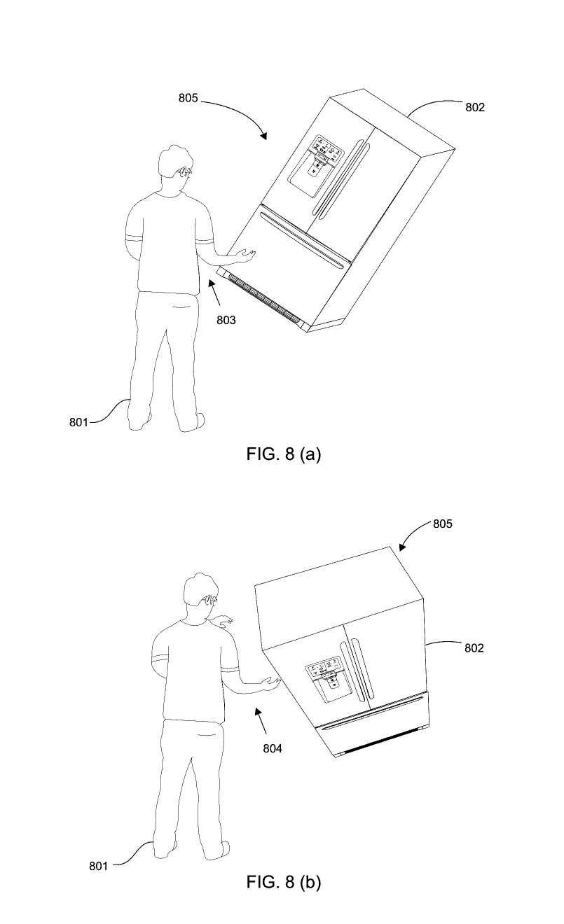

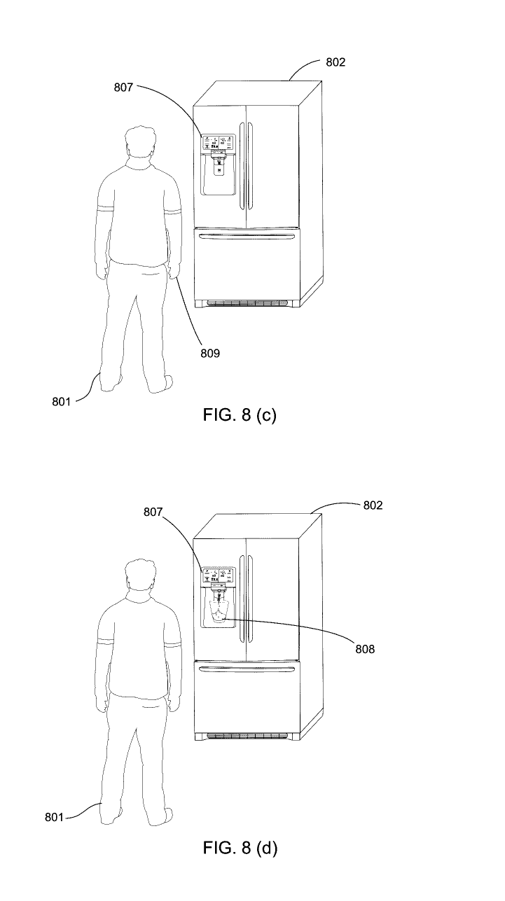

FIG. 8(a)-FIG 8(d) illustrates an example of the invention where a man appears wearing a see-through head mount display (HMD) 801 and interacts with a virtual refrigerator for rotating a virtual refrigerator 802 in different orientation and automatic demonstration of dispensing of ice. User request for a virtual refrigerator 802 to be shown, same is shown in FIG. 8(a). User further interacts with the virtual refrigerator 802 through gestures 803, 804 to rotate the refrigerator in different orientations 805, 806 as shown in FIG. 8(a) and FIG. 8 (b). In FIG. 8(c), the man interacts through gesture 809 with the virtual refrigerator 802 to understand automatic dispensing of ice using a control panel 807 of the virtual refrigerator 802. In FIG. 8(d), automatic orderly steps of appearing a virtual glass 808, pressing of a button on the control panel 807 for controlling dispensing of ice, and dispensing of ice into the virtual glass 808, are shown. While the demonstration is going on, the man can rotate the refrigerator by 360 degrees to be in any orientation.

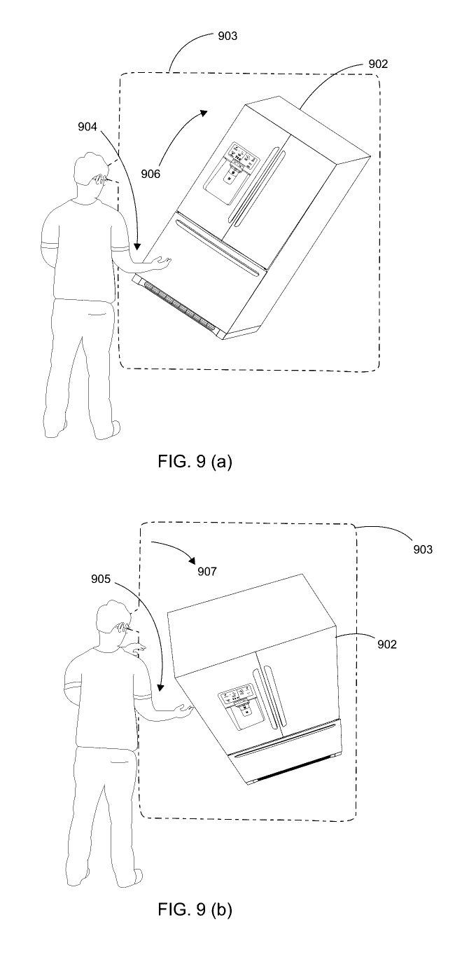

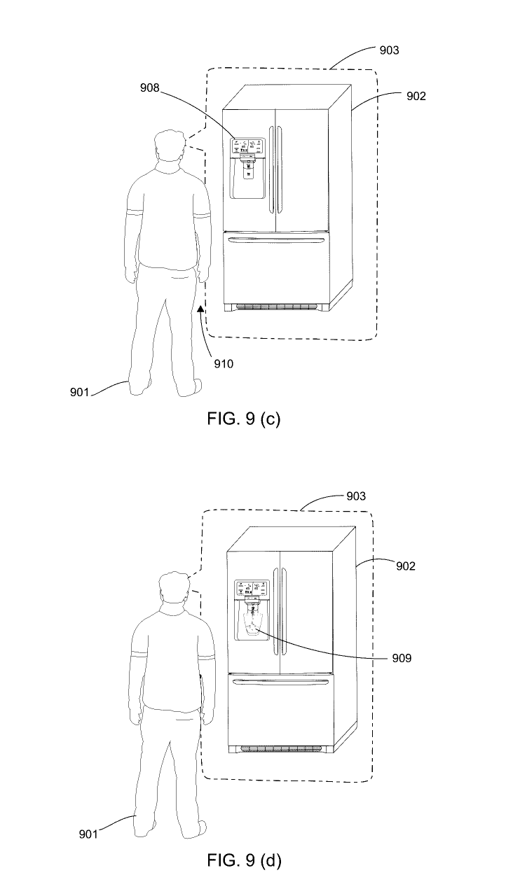

FIG. 9(a)-FIG 9(d) illustrates an example of the invention where a man appears wearing an immersive head mount display (HMD) 901 and interacts with a virtual refrigerator 902 for rotating a virtual refrigerator 902 in different orientation and automatic demonstration of dispensing of ice. User request for a virtual refrigerator 902 to be shown, same is shown in FIG. 9(a). User further interacts with the virtual refrigerator 902 through gestures 904, 905 to rotate the refrigerator 902 in different orientations 806, 807 as shown in FIG. 9(a) and FIG. 9(b). In FIG. 9(c), the man interacts through gesture 910 with the virtual refrigerator 902 to understand automatic dispensing of ice using a control panel 908 of the virtual refrigerator 902. In FIG. 9(d), automatic orderly steps of appearing a virtual glass 909, pressing of a button on the control panel 908 for controlling dispensing of ice, and dispensing of ice into the virtual glass 909, are shown. While the demonstration is going on, the man can rotate the refrigerator by 360 degrees to be in any orientation.

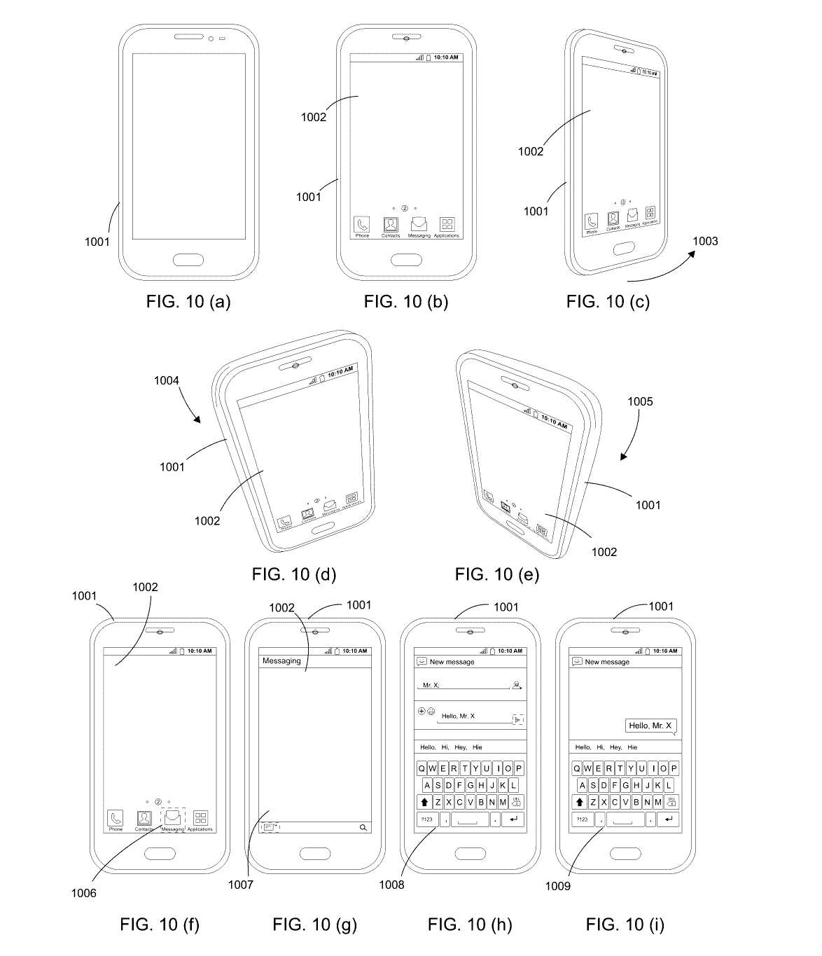

FIG. 10(a)-FIG 10(i) illustrates an example of the invention where a virtual mobile 1001 is interacted to rotate in various orientations and further interacted for demonstration of using a messaging application 1006 stored on the virtual mobile. The FIG. 10(a) shows a virtual mobile phone 1001 and in FIG. 10(b) the mobile 1001 is switched on with a start up interface. The user interacts with the mobile 1001 to rotate the virtual mobile 1001 in various orientations 1003, 1004 and 1005 while the start-up screen is “on” in FIG. 10(c) FIG. 10(d). In FIG. 10(f), the user requests for demonstration using the messaging application 1006. In FIG. 10(g) FIG. 10(i), automatically and sequentially showing:
the messaging application is opened and accessed and shown as interface 1007,
in further interfaces 1008, 1009 a virtual keyboard with GUI of the mobile phone appears with virtual keys and text interface for posting messages and interface for showing posted messages with keys being pressed and message is being typed and further posted.

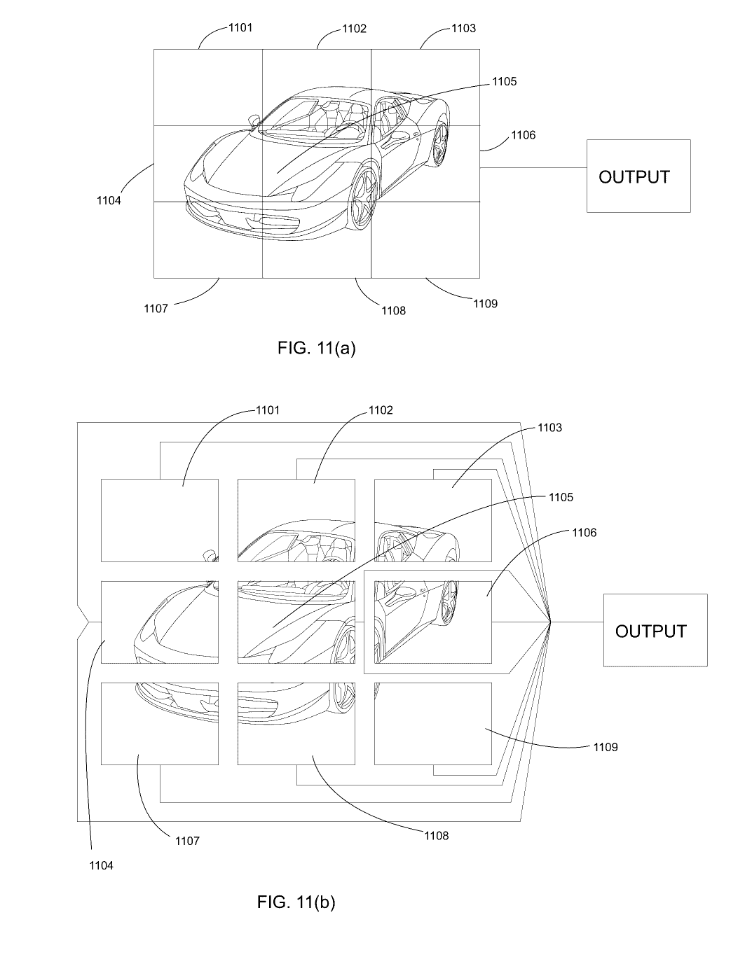

FIG. 11(a) illustrates an example of the invention where a 3D model is displayed on a video wall, wherein the video wall is connected to an output to receive the virtual object. Also interactions and demonstrations are shown on the video wall. FIG. 11(b) shows the video wall is made of multiple screens 1101, 1102, 1103, 1104, 1105, 1106, 1107, 1108, 1109, and receiving synchronized output regarding parts of the 3D model and interactive view of the parts of the 3D model, such that on consolidation of the screens, they behave as single screen to show interactive view of the 3D model.

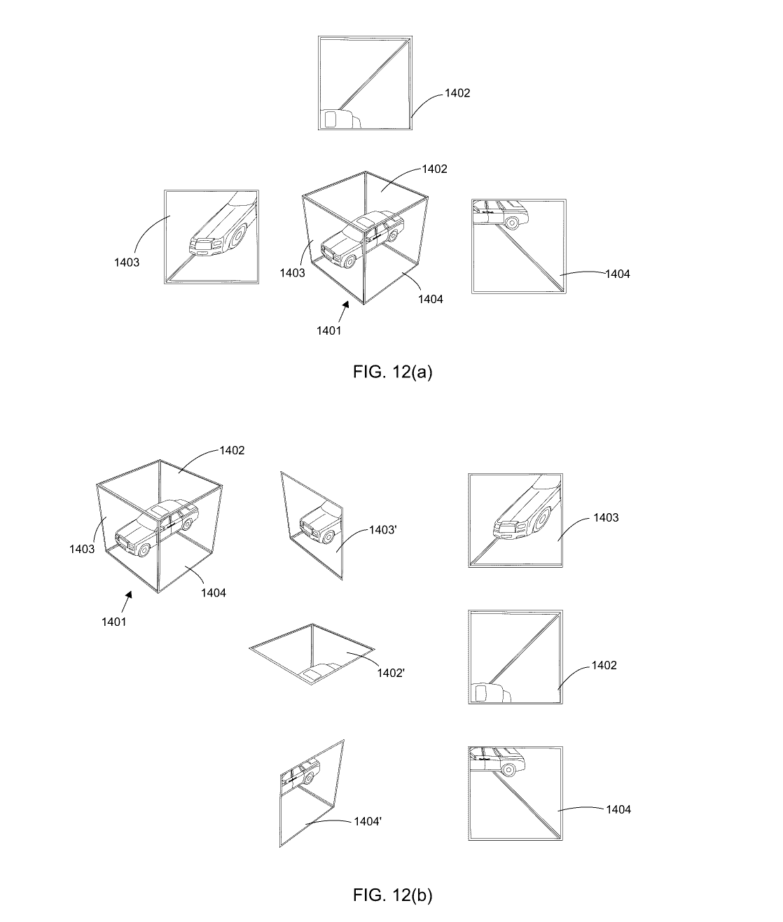

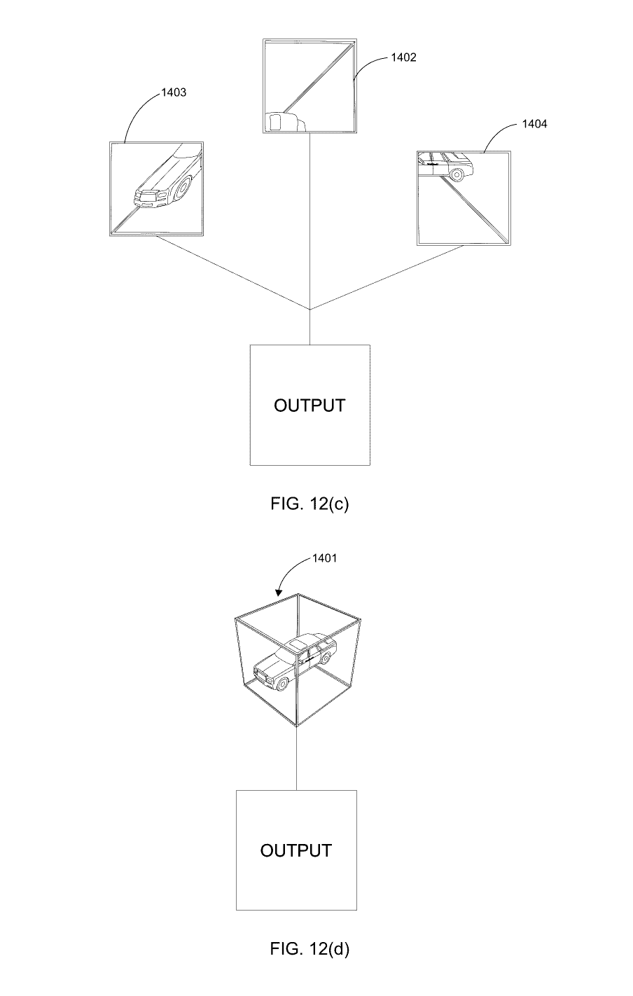

FIG. 12(a) to FIG. 12(d) illustrates an example of the invention where a cube based display 1401 is shown which is made of different electronic display 1402, 1403, 1404. User is seeing the car in cube 1401 which seems to be placed inside the cube due to projection while actually different screens are displaying different shape car parts. In FIG. 12(b), rendering engine's is parting the car image in the shape of 1403′, 1402′ and 1404′ there after 1403′, 1402′, 1404′ are skew to the shape of 1403, 1402 and 1404 respectively. FIG. 12(c), the output from rendering engine's is going to different display's in the form of 1403, 1402 and 1404. FIG. 12(d) shows the cube at particular orientation which gives illusion of car to be placed inside it and operation of car's part/s can be automatically operated to demonstrate the functionality interaction by input using any input device.

The Cube can be rotated in different orientation, where change in orientation will work as rotation scene in different plane in such a way at particular orientation of cube, particular image displayed so depending on the orientation, the image is cut into one piece, two piece or three piece. These different pieces wrap themselves to fit in different display in such a way so that the cube made of such display displays a single scene which gives a feeling that the object is inside the cube. Apart from cube, even hexagonal, pentagonal, sphere shaped display with same technique can show the 3D model of the object giving feel that the 3D model is inside the display

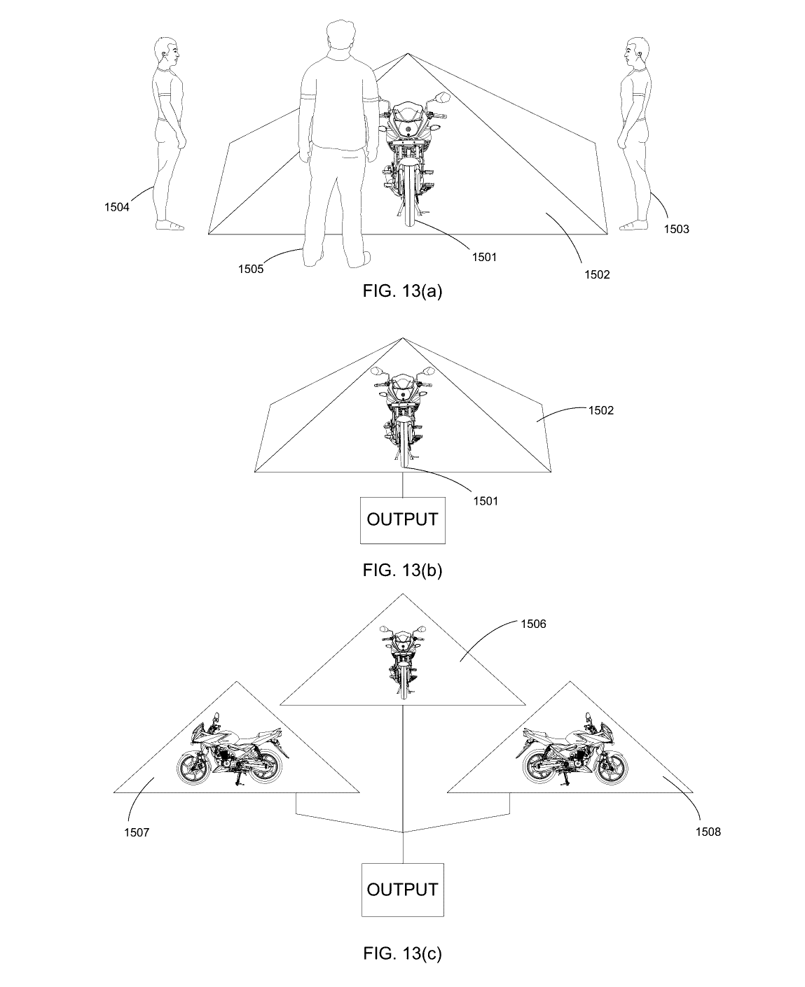

FIG. 13(a) shows a display system 1502 made of multiple display based on pepper's ghost technique. It is showing bike 1501. User see the bike from different positions 1503, 104 and 1505. FIG. 13(b) show the display system 1502 is connected to the output and showing bike 1501. FIG. 13(c)show that the display system 1501 show different face of bike in different display 1507, 1506 and 1508 giving an illusion of a 3d bike standing at one position showing different face from different side.

FIG. 14 is a simplified block diagram showing some of the components of an example client device 1612. By way of example and without limitation, client device is a computer equipped with one or more wireless or wired communication interfaces.

As shown in FIG. 14, client device 1612 may include a communication interface 1602, a user interface 1603, a processor 1604, and data storage 1605, all of which may be communicatively linked together by a system bus, network, or other connection mechanism.

Communication interface 1602 functions to allow client device 1612 to communicate with other devices, access networks, and/or transport networks. Thus, communication interface 1602 may facilitate circuit-switched and/or packet-switched communication, such as POTS communication and/or IP or other packetized communication. For instance, communication interface 1602 may include a chipset and antenna arranged for wireless communication with a radio access network or an access point. Also, communication interface 1602 may take the form of a wireline interface, such as an Ethernet, Token Ring, or USB port. Communication interface 1602 may also take the form of a wireless interface, such as a Wifi, BLUETOOTH®, global positioning system (GPS), or wide-area wireless interface (e.g., WiMAX or LTE). However, other forms of physical layer interfaces and other types of standard or proprietary communication protocols may be used over communication interface 102 Furthermore, communication interface 1502 may comprise multiple physical communication interfaces (e.g., a Wifi interface, a BLUETOOTH® interface, and a wide-area wireless interface).

User interface 1603 may function to allow client device 1612 to interact with a human or non-human user, such as to receive input from a user and to provide output to the user. Thus, user interface 1603 may include input components such as a keypad, keyboard, touch-sensitive or presence-sensitive panel, computer mouse, joystick, microphone, still camera and/or video camera, gesture sensor, tactile based input device. The input component also includes a pointing device such as mouse; a gesture guided input or eye movement or voice command captured by a sensor, an infrared-based sensor; a touch input; input received by changing the positioning/orientation of accelerometer and/or gyroscope and/or magnetometer attached with wearable display or with mobile devices or with moving display; or a command to a virtual assistant.

User interface 1603 may also include one or more output components such as a cut to shape display screen illuminating by projector or by itself for displaying objects, cut to shape display screen illuminating by projector or by itself for displaying virtual assistant.

User interface 1603 may also be configured to generate audible output(s), via a speaker, speaker jack, audio output port, audio output device, earphones, and/or other similar devices, now known or later developed. In some embodiments, user interface 1603 may include software, circuitry, or another form of logic that can transmit data to and/or receive data from external user input/output devices. Additionally or alternatively, client device 112 may support remote access from another device, via communication interface 1602 or via another physical interface.

Processor 1604 may comprise one or more general-purpose processors (e.g., microprocessors) and/or one or more special purpose processors (e.g., DSPs, CPUs, FPUs, network processors, or ASICs).

Data storage 1605 may include one or more volatile and/or non-volatile storage components, such as magnetic, optical, flash, or organic storage, and may be integrated in whole or in part with processor 1604. Data storage 1605 may include removable and/or non-removable components.

In general, processor 1604 may be capable of executing program instructions 1607 (e.g., compiled or non-compiled program logic and/or machine code) stored in data storage 1505 to carry out the various functions described herein. Therefore, data storage 1605 may include a non-transitory computer-readable medium, having stored thereon program instructions that, upon execution by client device 1612, cause client device 1612 to carry out any of the methods, processes, or functions disclosed in this specification and/or the accompanying drawings. The execution of program instructions 1607 by processor 1604 may result in processor 1604 using data 1606.

By way of example, program instructions 1607 may include an operating system 1611 (e.g., an operating system kernel, device driver(s), and/or other modules) and one or more application programs 1610 installed on client device 1612 Similarly, data 1606 may include operating system data 1609 and application data 1608. Operating system data 1609 may be accessible primarily to operating system 1611, and application data 1608 may be accessible primarily to one or more of application programs 1610. Application data 1608 may be arranged in a file system that is visible to or hidden from a user of client device 1612.

Application Data 1608 includes 3D model data that includes three dimensional graphics data, texture data that includes photographs, video, interactive user controlled video, color or images, and/or audio data, and/or virtual assistant data that include video and audio.

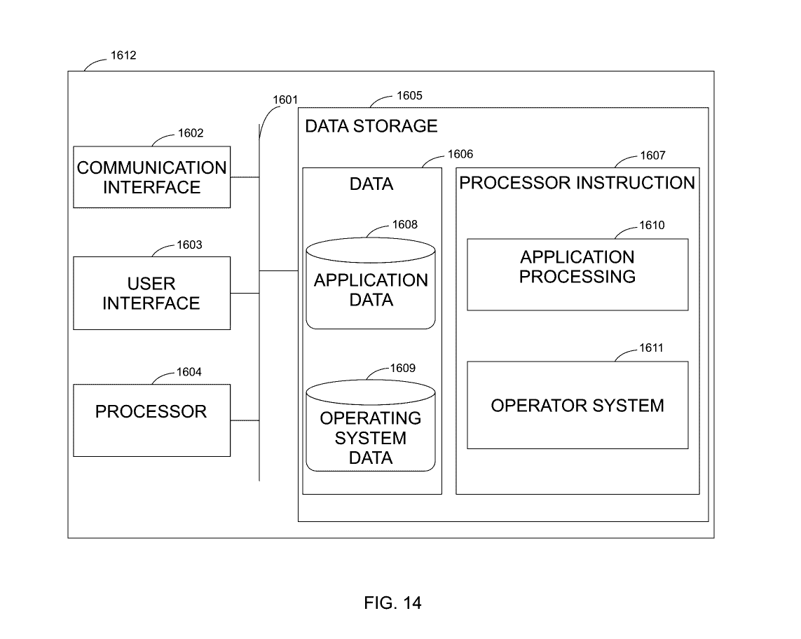

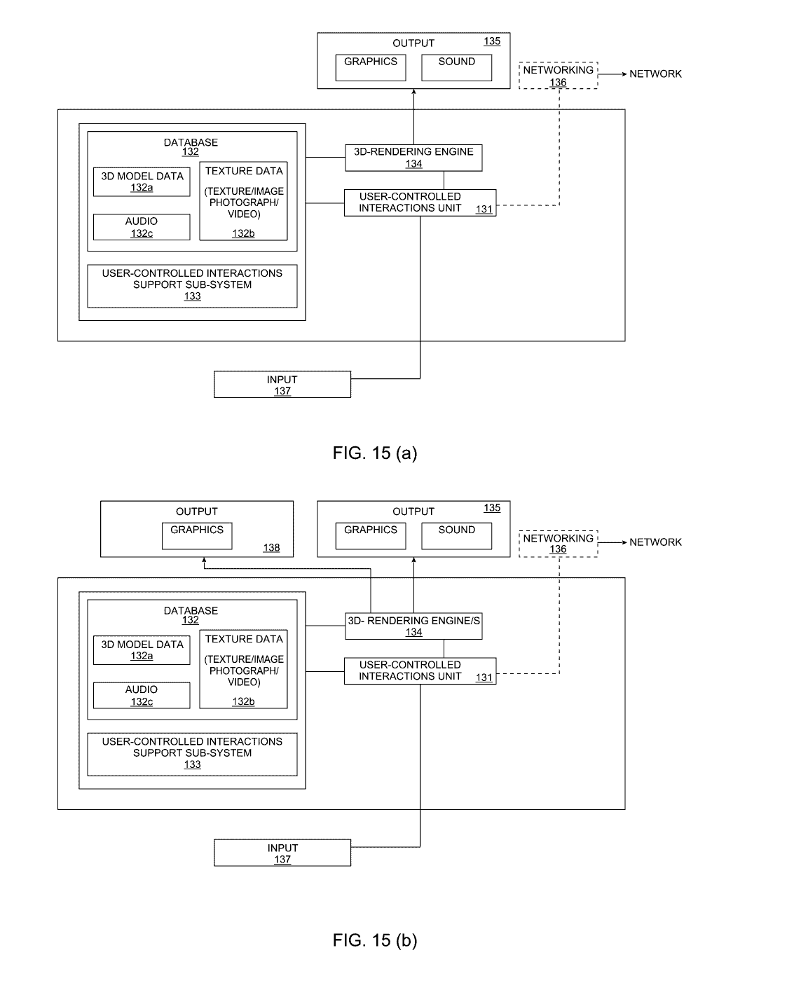

In one embodiment as shown in FIG. 15(a), a user controlled interaction unit 131 uses 3D model graphics data/wireframe data 132a, texture data 132b, audio data 132c along with user controlled interaction support sub-system 133 to generate the output 135, as per input request for interaction 137, using rendering engine 134. The interaction for understanding the functionality is demonstrated by ordered operation/s of part/s of 3d model. Such functionalities are coded in sequential and or parallel fashion such as two or more functionality may merge together while it is requested and leave the few steps if required. Such functionalities are coded so that other kind of interaction may be performed simultaneously. User controlled interaction unit 131 use such coded functionalities to generate the required output 135. Basically user controlled unit contains the logic for all functionalities and also set/s of functionalities in parallel/sequential order to demonstrate the understanding of working of some operation which is demonstrated by more than one functioning of part/s. While some part/s of 3D model of object performing automatic functioning to show the performing of some operation, other part/s of the 3D model in which interaction is possible, can be interacted to perform the functioning.

The user-controlled interactions unit 131 includes logic for making group of functioning of part/s of 3D model which will be performed in sequence or parallel order upon getting input to understand some particular operation of 3D model of the object. The user-controlled interactions unit 131 includes logic for performing extrusive and intrusive interactions, for performing liquid and fumes flow interactions, for performing addition interactions, for performing deletion interactions, for performing time-bound changes based interactions, for performing environment mapping based interactions, for performing interaction for getting un-interrupted view of internal parts using transparency-opacity effect, for performing immersive interactions, for performing inter-interactions, for performing engineering disintegration interactions with the displayed 3D model. The user control interaction unit 131 is the main logic that utilizes different sub-system 133, database 132, and according to user input generates output and a corresponding scene or user-controlled interaction response is rendered using a 3D rendering engine in real time/near real time.

The texture data 132b includes textures obtained from photographs, use of video file as texture, color or images. Texture data include texture for 3D model and its functioning surfaces such as for showing the function of digital /electronic part. 3D model can be textured using computer generated colors, brightness, hue, shades as well. It may be added in 3d model generation environment or during the rendering by using libraries for color, shades or other properties which are associated with rendering engine. For providing realistic look texture may be prepared from real photographs, images, videos. Video is used as texture in the 3D model only for that surface/s which corresponds to functioning part such as light-emitting parts in the real object. The use of video enhances reality in displaying dynamic texture changes for function part for lighting effect (one of extrusive and intrusive interactions). Multiple textures pre-calibrated on 3D model UV layouts can be stored as texture data for one/same surface in the database 132, which are called for or fetched dynamically by the user-controlled interaction unit 131 during the user-controlled interactions.

According to another embodiment for the texturing of a three-dimensional 3D model of a 3D object using photograph and/or video, the method comprising:
using plurality of photographs and/or video of the real 3D object and/or the real 3D object's variants, where said photographs and/or video are used as texture data;
(a). selecting one or more surfaces of one or more external and/or internal parts of the 3D model
(b). carrying out UV unwrap of selected surface/s of the 3D model for generating UV layout for each selected surface;
(c). identifying texture data corresponding to each UV layout, and applying one or more identified photographs and/or video as texture data on each corresponding UV layout, while performing first calibration for photographs and/or first calibration for video;
(d). after first calibration and for the selected surface/s, joining or adjacently placing all UVs of related UV layouts comprising first calibrated texture to form texture for the selected surface/s, while performing second calibration; and
(e). repeating steps (a) to (d) until all chosen external and/or internal surfaces of the 3D model are textured using photographs and/or video, while at the joining of surfaces of different set of the selection of surfaces, applying third calibration for making seamless texture during each repetition step,
wherein the calibrated textures and corresponding 3D-model is stored as texture data and 3D-model data respectively for use in user-controlled interactions implementation,
wherein video is used as a texture in the 3D model for surfaces corresponding to functioning parts in real object, and for surfaces whose texture changes dynamically during operation of said functioning parts, and
wherein at least one of the above steps is performed on a computer.

The user-controlled interaction support sub-system 133 includes a sound engine for producing sound as per user-controlled interaction, a motion library responsible for animation of the virtual product assistant which include rigging/animation data of 3D virtual model motion/expression or animation of one or more parts in the 3D model such rotating the wheel continually. The virtual operating sub-system for providing functionality of operation of electronic or digital parts in the displayed 3D-model/s depending on the characteristics, state and nature of displayed object. It stores the functionality of GUI look and output for different input via 3D model part/s or GUI itself or other kind of inputs and also make response for different input of GUI to make a response for part/parts of 3D model or other GUI based output an Artificial Intelligence (AI) engine for decision making and prioritizing user-controlled interactions response, a scene graph for primarily for putting more than one 3D object in scene say more than two 3D model of bikes, one bike or one 3D model etc, a terrain generator for generating surrounding, in case say 3D model is placed in some environment, lighting and shadow for generating the effect of light of 3D model, a shader for providing visual effects such as colour shades, and a physics/simulation engine for generating simulation effect, for example for showing the functioning of folding the roof of car, to show wrinkles in folding material.

According to another embodiment, for an example, “A user not only can check the laptop looks and compare specification, but can understand the functionalities of laptop just in real life scenario such as switching it to judge start-up time, which is the real start-up time for the said product, if the product would have been started in real life set-up. The digital interaction/electronic display interaction is shown on some surface of 3D model. Here as the control when reach over the GUI of digital/electronic interaction surface, the control change and it goes from the 3D model to digital/electronic interaction layer for example; drag command to virtual mobile display goes to GUI but not to the 3D model which make change in GUI possible.

According to another embodiment, during mirror effect and immersive interactions, the user-controlled interactions unit 131 uses live video input from camera, which is directly passed to message handler. The message handler further transmits the input or interaction command to the user-controlled interactions unit 131 for identification and further processing.

Initially, user input can generate a network message, an operating system message, or is direct input. The network message means a command or event generated by the user input which is sent by server software to client software in same machine or any host connected through network for an action by the client. The operating system message is a command or event generated by user input by a device handler to the client software via operating system inter process communication/message queue/or an action by the client device. In the direct input or direct messaging, the device handler and the client software are a single application, hence commands or event are directly bound to the device handler. A message Interpreter interprets the message (command/event) based upon the context and calls the appropriate handler for an action. Message handler, or event handler are logic blocks associated with an action for controls. User input can be provided using infrared based sensor, voice command based sensor, camera based sensor, or touch based screens.

According to another embodiment, Virtual assistant may be displayed in same 3d graphics environment or it may be displayed in a separate environment. It may have different virtual assistant sub system which included data base related to 3d model data of Virtual assistant, texture data, rigging & animation data, logic for movement according to output, while in case of 2d virtual assistant, image/video data and image processing based logic to generate expression. For responding it uses a voice to text convertor, a logic based on NLP and AI along with response set data and text to voice convertor, response in terms of voice/text is generated. The virtual assistant sub system may be a separate unit which in synchronise with 15 (a) is displayed and work together or this system may work together or may be inside the same system by adding its database with 3D model of product database and support logic with user controlled support sub system and user controlled unit for receiving input and generate output using libraries and logic of voice to text convertor, a logic based on NLP and AI along with response set data and text to voice convertor, response in terms of voice/text is generated and display the virtual model.

The virtual product assistant sub-system includes:

Instructions stored in a non-transitory computer readable storage system executable by the one or more processors that upon such execution cause the one or more processors to perform operations comprising:
receiving a user input, the input is in the form of at least one natural language speech such as in English language provided using a hardware voice input device that is in communication with the virtual product assistant sub-system, where the user voice input is either a product information query for gaining product information in real-time or an introduction related speech for introduction and salutation;
processing voice-based input to retrieve relevant information as per received product information query or introduction related speech;
outputting reply in the form of natural language speech with lip-synchronization of spoken words displayed in graphics accordance to the current 3D model display state displayed on the electronic panel system, wherein the lip-synchronization occurs dynamically in image or video of displayed virtual product assistant, using one or more processors, by an image processor. During outputting reply in the form of natural language speech, the output speech is customizable for pronunciation, masculine and feminine voice using a sound engine. The processing voice-based input to retrieve relevant information further comprises:
performing speech recognition using voice recognition engine to transcribe spoken phrase or sentence into text acceptable by said virtual assistant sub-system;
ascertaining meaning of the text to differentiate between introduction query and product information query using a Natural Language Processing (NLP) engine, to aid in matching of input with corresponding product information data set;
if input is a product information query, matching the input with active product information data set relevant to the product displayed on the soft-copy display device;
if input is introduction related query, matching the input with introduction related query data set relevant to the introduction query.

The output is as per the query with synchronized graphics. The voice input from a microphone is transmitted to the message handler and then passes to the virtual product assistant unit.

The virtual-assistant sub-system gets configured to reply to queries with respect to current specific product displayed on the soft-copy display screen.

For example, a user may ask following queries using the microphone/text when a 3D model of bike of a particular model, say model X is displayed on the soft-copy display device and receive corresponding replies from the virtual product assistant:
Query-1: What is the mileage of this bike?
Reply-1: Mileage of this bike is 65 km per liter of petrol.
Query-2: What is the special feature about this bike?
Reply-2: It has an excellent suspension system and a sports bike-like looks.
Query-3: In how many variants is it available?
Reply-3: There are two variants and 6 colors available for each variant.

Virtual assistant may be of 3d made up of using 3d graphics data, texture data, rigging & morphing/animation data to generate expression. It may be made of 2D graphics and expression is generated by image processing also it may be made of multiple pre recorded/rendered video clips.

According to another embodiment as shown in FIG. 15(b), sometime when multi-display system is used to show output 135, 138 then more than one rendering engines 134 using one or more than one processing units 131 may be used to generate separate output 135, 138 which goes to different display.

Application Programs 1610 includes programs for performing the following steps, when executed over the processor:
generating and displaying a first view of the 3D model;
receiving an user input, the user input are one or more interaction commands comprises interactions for understanding particular functionality of the 3D model, wherein functionality of the 3D model is demonstrated by automatic operation of the part/s of the 3D model which operates in an ordered manner to perform the particular functionality;
identifying one or more interaction commands;
in response to the identified command/s, rendering of corresponding interaction to 3D model of object with or without sound output using texture data, computer graphics data and selectively using sound data of the 3D-model of object; and
displaying the corresponding interaction to 3D model,
   wherein operating in Ordered manner includes parallel or sequential operation of part/s

Application program 1610 further includes a set of system libraries comprises functionalities for:
producing sound as per user-controlled interaction;
animation of one or more parts in the 3D model;
providing functionality of operation of electronic or digital parts in the displayed 3D model/s depending on the characteristics, state and nature of displayed object;
decision making and prioritizing user-controlled interactions response;
putting more than one 3D model/s in scene;
generating surrounding or terrain around the 3D model;
generating effect of dynamic lighting on the 3D model;
providing visual effects of color shades; and
generating real-time simulation effect;

Rendering of corresponding interaction to 3D model of object in a way for displaying in a display system made of one or more electronic visual display or projection based display or combination thereof.

The display system can be a wearable display or a non-wearable display or combination thereof.

The non-wearable display includes electronic visual displays such as LCD, LED, Plasma, OLED, video wall, box shaped display or display made of more than one electronic visual display or projector based or combination thereof.

The non-wearable display also includes a pepper's ghost based display with one or more faces made up of transparent inclined foil/screen illuminated by projector/s and/or electronic display/s wherein projector and/or electronic display showing different image of same virtual object rendered with different camera angle at different faces of pepper's ghost based display giving an illusion of a virtual object placed at one places whose different sides are viewable through different face of display based on pepper's ghost technology.

The wearable display includes head mounted display. The head mount display includes either one or two small displays with lenses and semi-transparent mirrors embedded in a helmet, eyeglasses or visor. The display units are miniaturised and may include CRT, LCDs, Liquid crystal on silicon (LCos), or OLED or multiple micro-displays to increase total resolution and field of view.

The head mounted display also includes a see through head mount display or optical head-mounted display with one or two display for one or both eyes which further comprises curved mirror based display or waveguide based display. See through head mount display are transparent or semi transparent display which shows the 3d model in front of users eye/s while user can also see the environment around him as well.

The head mounted display also includes video see through head mount display or immersive head mount display for fully 3D viewing of the 3D-model by feeding rendering of same view with two slightly different perspective to make a complete 3D viewing of the 3D-model. Immersive head mount display shows 3d model in virtual environment which is immersive.

In one embodiment, the 3D model moves relative to movement of a wearer of the head-mount display in such a way to give to give an illusion of 3D model to be intact at one place while other sides of 3D model are available to be viewed and interacted by the wearer of head mount display by moving around intact 3D model.

The display system also includes a volumetric display to display the 3D model and interaction in three physical dimensions space, create 3-D imagery via the emission, scattering, beam splitter or through illumination from well-defined regions in three dimensional space, the volumetric 3-D displays are either auto stereoscopic or auto multiscopic to create 3-D imagery visible to an unaided eye, the volumetric display further comprises holographic and highly multiview displays displaying the 3D model by projecting a three-dimensional light field within a volume.

The input command to the said virtual assistant system is a voice command or text or gesture based command. The virtual assistant system includes a natural language processing component for processing of user input in form of words or sentences and artificial intelligence unit using static/dynamic answer set database to generate output in voice/text based response and/or interaction in 3D model.

Application program 1610 further includes a set of system libraries comprises functionalities for:
producing sound as per user-controlled interaction;
animation of one or more parts in the virtual model;
providing functionality of operation of electronic or digital parts in the displayed virtual model/s depending on the characteristics, state and nature of displayed object;
decision making and prioritizing user-controlled interactions response;
putting more than one virtual model/s in scene;
generating surrounding or terrain around the virtual model;
generating effect of dynamic lighting on the virtual model;
providing visual effects of colour shades; and
generating real-time simulation effect;

Other types of user controlled interactions are as follows:

interactions for colour change of displayed virtual model,
operating movable external parts of the virtual model,
operating movable internal parts of the virtual model,
interaction for getting un-interrupted view of interior or accessible internal parts of the virtual model,
transparency-opacity effect for viewing internal parts and different parts that are inaccessible,
replacing parts of displayed object with corresponding new parts having different texture,
interacting with displayed object having electronic display parts for understanding electronic display,
operating system functioning, vertical tilt interaction and/or horizontal tilt interaction,
operating the light-emitting parts of virtual model of object for functioning of the light emitting parts,
interacting with virtual model for producing sound effects,
engineering disintegration interaction with part of the virtual model for visualizing the part within boundary of the cut-to-screen, the part is available for visualization only by dismantling the part from the entire object,
time bound change based interactions to represent of changes in the virtual model demonstrating change in physical property of object in a span of time on using or operating of the object,
physical property based interactions to a surface of the virtual model, wherein physical property based interactions are made to assess a physical property of the surface of the virtual model
real environment mapping based interaction, which includes capturing an area in vicinity of the user, mapping and simulating the video/image of area of vicinity on a surface of the virtual model
addition based interaction for attaching or adding a part to the virtual model,
deletion based interaction for removing a part of virtual model,
interactions for replacing the part of the virtual model,
demonstration based interactions for requesting demonstration of operation of the part/s of the object which are operated in an ordered manner to perform a particular operation,
linked-part based interaction, such that when an interaction command is received for operating one part of virtual model, than in response another part linked to the operating part is shown operating in the virtual model along with the part for which the interaction command was received,
liquid and fumes flow based interaction for visualizing liquid and fumes flow in the virtual model with real-like texture in real-time
immersive interactions, where users visualize their own body performing user-controlled interactions with the virtual computer model.

The displayed 3D model is preferably a life-size or greater than life-size representation of real object.

1. A computer implemented method for visualization of a 3D model of an object, the method comprising:
rendering and displaying the 3D model;
receiving an user input, the user input are one or more interaction commands comprises interactions for understanding particular functionality of the 3D model, wherein functionality of the 3D model is demonstrated by automatic operation of the part/s of the 3D model which operates in an ordered manner to perform the particular functionality;
identifying one or more interaction commands;
in response to the identified command/s, rendering of corresponding interaction to 3D model of object using texture data, and computer graphics data of the 3D-model of object; and
displaying the corresponding interaction to 3D model,
Wherein operating in Ordered manner includes parallel or sequential operation of part/s.

2. The method according to claim 1, wherein other part/s of virtual object is available for user controlled interactions while such operation is being performed.

3. The method according to claim 1, wherein the demonstration of the particular functionality comprises demonstration of multiple steps, wherein the steps are controlled by pausing the step/s and/or replaying the step/s.

4. The method according to claim 1, wherein the object comprises an electronic screen and correspondingly the 3D model comprises a virtual electronic display, interacting with the 3D model for understanding functionality to navigate to an application in the 3D model and/or understating functionality of the application by automatically demonstrating the required step in ordered manner, wherein such demonstration is shown by change in graphics and/or multimedia data on the virtual electronic display in synchronization with automatically operating the part/s of virtual 3D model.

5. The method according to claim 1, wherein two or more 3D models of two or more objects which are communicatively coupled to each other, wherein interacting with 3D model/s for understanding a particular functionality pertaining communication among the 3D model/s by automatically demonstrating steps of operation of part/s and/or movement of 3D model/s and/or change in GUIs of virtual electronic display or multimedia data of 3D model/s in ordered manner.

6. The method according to claim 1, wherein interaction to understand functionality of 3D model with gesture control comprises
displaying virtual human body and/or virtual human body part/s with/without 3D model of gesturing object/s wherein gesturing object comprises a virtual object representing object used by human to give gesture command.
ordered artificial representation of gestures through movement/posture or activity of virtual human body and/or virtual human body part/s with/without 3D model of gesturing object/s in synchronization with operation of 3D model part/s or any movement of 3D model.

7. The method according to claim 1, wherein the 3D model comprises inflatable and/or deflatable and/or folding part/s, and interacting with the part/s to understand their inflation and/or deflation and/or folding feature by automatically demonstrating the inflation and/or deflation and/or folding of the part/s in ordered manner.

8. The method according to claim 1, wherein new 3D model/s of new object/s are introduced in interactive manner and/or isolated manner with the existing 3D model for automatically demonstrating the particular functionality in an ordered manner.

9. The method according to claim 1, wherein demonstration of the operation is further guided by text or voice, wherein the text or voice refers to the steps involved in performance of the operation.

10. The method according to claim 9, wherein a virtual character is introduced and the voice is lisped and/or expressed with/without facial expression and/or body posture.

11. The method according to claims 1, wherein the interaction command comprises extrusive interaction and/or intrusive interactions and/or a time bound change based interaction and/or a real environment mapping based interaction and combination thereof, as per user choice and/or as per characteristics, state and nature of the said object,
wherein the time bound changes refers to representation of changes in 3D model demonstrating change in physical property of object in a span of time on using or operating of the object, and real environment mapping refers to capturing a real time environment, mapping and simulating the real time environment to create a simulated environment for interacting with the 3D model.

12. The method according to claim 11, wherein the interaction commands are adapted to be received before and/or during and/or after interactions for understanding particular functionality of the 3D model.

13. The method according to claim 11, wherein the extrusive interaction comprises at least one of:
interacting with a 3D model representing an object having a display for experiencing functionality of Virtual GUI on virtual display of displayed 3D model; to produce the similar changes in corresponding GUI of 3D model as in GUI of the object for similar input;
interacting for operating and/or removing movable parts of the 3D model of the object, wherein operating the movable parts comprises sliding, turning, angularly moving, opening, closing, folding, and inflating-deflating the parts
interacting with 3D model of object for rotating the 3D model in 360 degree in different planes;
operating the light-emitting parts of 3D-model of object for experiencing functioning of the light emitting part/s, the functioning of the light emitting part/s comprises glowing or emission of the light from light emitting part/s in 3D-model in similar pattern that of light emitting part/s of the object;
interacting with 3D-model of object having representation of electronic display part/s of the object to display response in electronic display part of 3D-model similar to the response to be viewed in electronic display part/s of the object upon similar interaction;
interacting with 3D-model of object having representation of electrical/electronic control of the object to display response in the 3D-model similar to the response to be viewed in the object upon similar interaction;
interacting with 3D-model for producing sound effects; or combination thereof.

14. The method according to the claim 13, wherein functioning of light emitting part is shown by a video as texture on surface of said light emitting part to represent lighting as dynamic texture change.

15. The method according to claim 11, the intrusive interactions comprises at least one of:
interacting with sub-parts of the 3D-model of the object, wherein sub-parts are those parts of the 3D-model which are moved and/or slided and/or rotated and/or operated for using the object;
interacting with internal parts of the 3D model, wherein the internal parts of the 3D-model represent parts of the object which are responsible for working of object but not required to be interacted for using the object, wherein interacting with internal parts comprising removing and/or disintegrating and-/or operating and/or rotating of the internal parts;
interacting for receiving an un-interrupted view of the interior of the 3D model of the object and/or the sub-parts;
interacting with part/s of the 3D model for visualizing the part by dismantling the part from the entire object;
interacting for creating transparency-opacity effect for converting the internal part to be viewed as opaque and remaining 3D model as transparent or nearly transparent;
disintegrating different parts of the object in exploded view; or combination thereof.

16. The method according to claim 11, wherein the real environment mapping based interactions comprises at least one of:
capturing an area in vicinity of the user, mapping and simulating the video/image of area of vicinity on a surface of 3D model to provide a mirror effect;
capturing an area in vicinity of the user, mapping and simulating the video/image of area of vicinity on a 3D space where 3D model is placed; or combination thereof.

17. The method according to the claims, wherein the interaction comprises liquid and fumes flow based interaction for visualizing liquid and fumes flow in the 3D model with real-like texture in real-time.

18. The method according to claim 1, wherein the interaction comprises immersive interactions, the immersive interactions are defined as interactions where users visualize their own body performing user-controlled interactions with the 3D model.

19. The method according to claim 1, wherein displaying of new interaction/s to the 3D-model while previously one or more interaction has been performed or another interaction/s is being performed on the 3-D model.

20. The method according to claim 1, wherein rendering of corresponding interaction to 3D model of object in a way for displaying in a display system made of one or more electronic visual display or projection based display or combination thereof.

21. The method according to the claim 20, wherein the display system is a wearable display or a non-wearable display or combination thereof;
wherein the non-wearable display comprises electronic visual displays such as LCD, LED, Plasma, OLED, video wall, box shaped display or display made of more than one electronic visual display or projector based or combination thereof,
wherein the non-wearable display comprises a pepper's ghost based display with one or more faces made up of transparent inclined foil/screen illuminated by projector/s and/or electronic display/s wherein projector and/or electronic display showing different image of same virtual object rendered with different camera angle at different faces of pepper's ghost based display giving an illusion of a virtual object placed at one places whose different sides are viewable through different face of display based on pepper's ghost technology
wherein the wearable display comprises head mounted display, the head mount display comprises either one or two small displays with lenses and semi-transparent mirrors embedded in a helmet, eyeglasses or visor, the display units are miniaturised and selectively comprises CRT, LCDs, Liquid crystal on silicon (LCos), or OLED or multiple micro-displays to increase total resolution and field of view,
wherein the head mounted display comprises a see through head mount display or optical head-mounted display with one or two display for one or both eyes which further comprises curved mirror based display or waveguide based display,
wherein the head mounted display comprises video see through head mount display or immersive head mount display for fully 3D viewing of the 3D-model by feeding rendering of same view with two slightly different perspective to make a complete 3D viewing of the 3D-model.

22-26. (canceled)

27. The method according to the claim 2, wherein the 3D model moves relative to movement of a wearer of the head-mount display in such a way to give to give an illusion of 3D model to be intact at one place while other sides of 3D model are available to be viewed and interacted by the wearer of head mount display by moving around intact 3D model.

28. The method according to the claim 20, wherein the display system comprises a volumetric display to display the 3D model and interaction in three physical dimensions space, create 3-D imagery via the emission, scattering, beam splitter or through illumination from well-defined regions in three dimensional space, the volumetric 3-D displays are either auto stereoscopic or auto multiscopic to create 3-D imagery visible to an unaided eye, the volumetric display further comprises holographic and highly multiview displays displaying the 3D model by projecting a three-dimensional light field within a volume.

29. The method according to claim 20, wherein the display system comprises more than one electronic display/projection based display joined together at an angle to make an illusion of showing the 3D model inside the display system, wherein the 3D model is parted off in one or more parts, thereafter parts are skew in shape of respective display and displaying the skew parts in different displays to give an illusion of 3d model being inside display system.

30. The method according to the claim 1, wherein the input command is received from one or more of a pointing device such as mouse; a keyboard; a gesture guided input or eye movement or voice command captured by a sensor, an infrared-based sensor; a touch input; input received by changing the positioning/orientation of accelerometer and/or gyroscope and/or magnetometer attached with wearable display or with mobile devices or with moving display; or a command to a virtual assistant.

31. The method according to claim 25, wherein command to the said virtual assistant system is a voice command or text or gesture based command, wherein virtual assistant system comprises a natural language processing component for processing of user input in form of words or sentences and artificial intelligence unit using static/dynamic answer set database to generate output in voice/text based response and/or interaction in 3D model.

32. A system of user-controlled realistic 3D simulation for enhanced object viewing and interaction experience comprising:
one or more input devices;
a display device;
a computer graphics data related to graphics of the 3D model of the object, a texture data related to texture of the 3D model, which is stored in one or more memory units; and
machine-readable instructions that upon execution by one or more processors cause the system to carry out operations comprising:
rendering and displaying the 3D model;
receiving an user input, the user input are one or more interaction commands comprises interactions for understanding particular functionality of the 3D model, wherein functionality of the 3D model is demonstrated by automatic operation of the part/s of the 3D model which operates in an ordered manner to perform the particular functionality;
identifying one or more interaction commands;
in response to the identified command/s, rendering of corresponding interaction to 3D model of object using texture data, and computer graphics data of the 3D-model of object; and
displaying the corresponding interaction to 3D model,
wherein operating in Ordered manner includes parallel or sequential operation of part/s.

33. A computer program product stored on a computer readable medium and adapted to be executed on one or more processors, wherein the computer readable medium and the one or more processors are adapted to be coupled to a communication network interface, the computer program product on execution to enable the one or more processors to perform following steps comprising:
rendering and displaying the 3D model;
receiving an user input, the user input are one or more interaction commands comprises interactions for understanding particular functionality of the 3D model, wherein functionality of the 3D model is demonstrated by automatic operation of the part/s of the 3D model which operates in an ordered manner to perform the particular functionality;
identifying one or more interaction commands;
in response to the identified command/s, rendering of corresponding interaction to 3D model of object using texture data, and computer graphics data of the 3D-model of object; and
displaying the corresponding interaction to 3D model,
Wherein operating in Ordered manner includes parallel or sequential operation of part/s.
